(19) United States
(12) Patent Application Publication
(10) Pub. No.: US 2026/0140396 A1
(43) Pub. Date: May 21, 2026

(54) System and Method For Fitting Prescription Lenses To Smart Glasses Using an Auxiliary Display Screen

(71) Applicant: Optikam Tech, Inc., Montreal (CA)

(72) Inventors: Bassem EL-HAJAL, Montreal (CA); Marco LANCIONE, Montreal (CA); Piotr SZYMBORSKI, Montreal (CA)

(21) Appl. No.: 19/298,175

(22) Filed: Aug. 12, 2025

Related U.S. Application Data
(63) Continuation-in-part of application No. 18/952,968, filed on Nov. 19, 2024.

(51) Int. Cl. G02C 7/02; G02C 11/00; G06F 1/16; G06T 7/73

(52) U.S. Cl. CPC G02C 7/027; G02C 11/10; G06F 1/163; G06F 1/1686; G06T 7/74; G06T 2207/30201

(57) ABSTRACT

A system and method for fabricating prescription lenses for smart glasses having a first camera. Using a first technique, a second camera views the smart glasses. A reference pattern of known dimensions is provided at a known position relative to the second camera. The reference pattern is imaged with the first camera and the image is used to calculate a spatial orientation between cameras. The second camera images the user wearing the frames. The image(s) are analyzed with a scale determined from the spatial orientation of the cameras to determine the ophthalmic measurements. The second camera can be part of a device that has a display screen. The display screen can be viewed with the first camera. Accordingly, the first camera collects a reimage of the user wearing the frames. The reimage can also be analyzed to determine the ophthalmic measurements needed to manufacture lenses for the frames.

### RELATED APPLICATIONS

The present application claims the benefit of co-pending U.S. patent application Ser. No. 18/952,968, filed Nov. 19, 2024.

### BACKGROUND OF THE INVENTION

### 1. Field of the Invention

The present invention relates to the systems and methodologies used to properly fit prescription lenses into eyeglasses. More particularly, the present invention relates to systems and methods that fit prescription lenses into the complex structure of smart glasses.

### 2. Description of Background Art

In the growing age of technology, many companies, such as Apple®, Google® and Meta® have integrated electronics into eyeglasses. Such eyeglasses are commercially known as “smart glasses” in the electronics industry and are exemplified by U.S. Pat. No. 9,285,592 to Olsson and U.S. Pat. No. 9,075,249 to Heinrich. When smart glasses are sold to the public, the vast majority of smart glasses sold are selected from a limited number of frame types and lens types that are offered by the source company. The lenses in the smart glasses typically have no optical power. However, as the popularity of smart glasses increases, the number of frames that are available has also increased. It is anticipated that in the near future, smart glasses technology can be incorporated into any eyeglass frame types that has enough room to hold the required electronics.

Currently, some companies enable a consumer to purchase customized smart glasses that contain prescription lenses. In such a scenario, a consumer must have an existing eyeglass prescription and must forward the prescription to the manufacturer. The manufacturer creates lenses in accordance with the prescription and assembles those lenses into the smart glasses. The peripheral dimensions of the lenses cannot be changed because the lenses must be fit into the complicated assembly of the smart glasses. The initial prescription is obtained in the standard manner. That is, the prescription is obtained from vision tests performed by an optometrist or similar eyecare professional. However, when the eyeglass prescription is created, the dimensions of the lenses used within smart glasses are not considered. Thus, certain measurements must be obtained to compensate for the dimensional requirements and lens glass types used in smart glasses.

In order for prescription lenses to be most effective, the manufacturing of the lenses should take into account the dimensions and shape of the frames to which the prescription lenses are going to be applied. Furthermore, custom fabrication of the lenses should also be varied to accommodate the anatomical features of the person who will wear the eyeglass frames. When prescription lenses are fitted for a particular set of frames and for a particular person, several measurements must be made in order to ensure that the prescription lenses are fabricated properly. The needed measurements are commonly referred to as “ophthalmic measurements” in the industry. Many of the needed ophthalmic measurements depend solely upon the style and model of the eyeglass frames selected. Other ophthalmic measurements depend upon the anatomy of the person being fitted. Still other ophthalmic measurements depend upon how the eyeglass frames sit upon the face when being worn in a normal manner and how an individual looks through their eyewear lenses when performing various daily activities.

In addition to a person's facial anatomy, the position of the head and the posture of the body also have significant effects on the proper fitting of eyeglasses. Few people have a fully erect posture and view their environment by only looking straight ahead. Rather, most people have a slight slouch. Furthermore, most people look slightly downward as they walk or when they sit. Some people also have a tendency to tilt their head to one side or another as they drive or read. Each one of these head positions causes a person to look through a slightly different section of the lenses in a set of eyeglasses.

In order to obtain all the anatomical measurements needed, eyeglass frames are worn by an individual. An optician or other technician then uses a variety of instruments to quantify the measurement variables needed to properly create prescription lenses for those eyeglass frames on that individual. However, when a consumer is purchasing smart glasses, this cannot be done. Due to the sophistication of the smart glasses, the smart glasses are not currently assembled in an eyeglass store or in an optometrist's office. Rather, smart glasses are assembled in the facilities of the smart glasses manufacturer. This is currently required because with smart glasses, electronic elements are integrated into, onto, and/or adjacent the lenses. The equipment needed to integrate the lenses into the frames is only found at the manufacturer's facilities. In future designs, it should be anticipated that the lenses of smart glasses will be made to be interchangeable and that prescription lenses can be manufactured and installed in the facilities of an optometrist or other eyecare professional.

In the prior art, there are systems that enable an individual to purchase prescription eyewear in a remote fashion. Some prior art systems use virtual 3D models of both the user's face and of the eyeglass frames. The virtual eyeglass frames are then superimposed over the virtual face to assess aesthetics and fit. Such prior art systems are exemplified by U.S. Pat. No. 9,817,248 to Yang. These prior art systems are sufficient for viewing the way eyeglasses look on a person. However, such systems simply position virtual eyeglasses in front of a virtual face. There are no adjustments for how gravity causes the eyeglasses to rest on the nose or how a person orients his/her head. Accordingly, any measurements that are obtained from such virtual model systems are only estimates and are not completely accurate.

U.S. Patent Application Publication No. 2014/0257839 to Suter, and U.S. Pat. No. 10,831,042 to El-Hajal et al. show prior art systems that enable a person to buy prescription eyewear online. The systems take an existing prescription for eyewear and adapt the prescription to any set of eyeglass frames that are selected online by the user. However, these systems rely on imagery of the person wearing the eyeglasses. The images are taken at different angles that can offset the measurements being made.

In most smart glasses, electronics exist that include various sensors and often a camera. The sensors include inclinometers and/or accelerometers. These sensors are typically used to detect the position of the head for the purposes of playing games or controlling various other running software. It has been discovered that the existing electronics in a set of smart glasses can be used to help obtain the ophthalmic measurements needed to properly fit the smart glasses with prescription lenses. The details of the invention are described and claimed below.

### SUMMARY OF THE INVENTION

The present invention is a system and method for fabricating prescription lenses for smart glasses, wherein the smart glasses include a first camera. To fabricate the lenses, a lens prescription is obtained for a user. Frames for smart glasses are selected from those commercially available. The user selects and wears the frames that are selected.

Using a first technique, a second camera is positioned to view the person wearing the smart glasses. A reference pattern of known dimensions is provided, wherein the reference pattern is at a known position relative to the second camera. The reference pattern can be any graphic or object that has known dimensions for measurement scale reference. The reference pattern is imaged with the first camera in the smart glasses. This produces a reference pattern image that is used to calculate the relative posit. Ion between the first camera and the second camera. With the relative position between cameras determined, the second camera is used to take at least one user image of the person wearing the frames. The user image(s) are analyzed with a scale determined from the relative position in space between the first camera and the second camera to determine the ophthalmic measurements needed to manufacture lenses for the frames.

Using the same equipment, a second technique can also be utilized. In the second technique, the second camera is part of a device that has a display screen. A reference pattern of known dimensions is provided, wherein the reference pattern is at a known position relative to the second camera. The second camera images the user wearing the frames and produces at least one display image. The display image is shown on the display screen. The display screen is viewed with the first camera in the smart glasses. Accordingly, the first camera collects at least one reimage of both the user wearing the frames and the reference pattern located at a known position in space from the second camera. The reimage is analyzed to determine the ophthalmic measurements needed to manufacture lenses for the frames.

### DETAILED DESCRIPTION OF THE DRAWINGS

For a better understanding of the present invention, reference is made to the following description of an exemplary embodiment thereof, considered in conjunction with the accompanying drawings, in which:

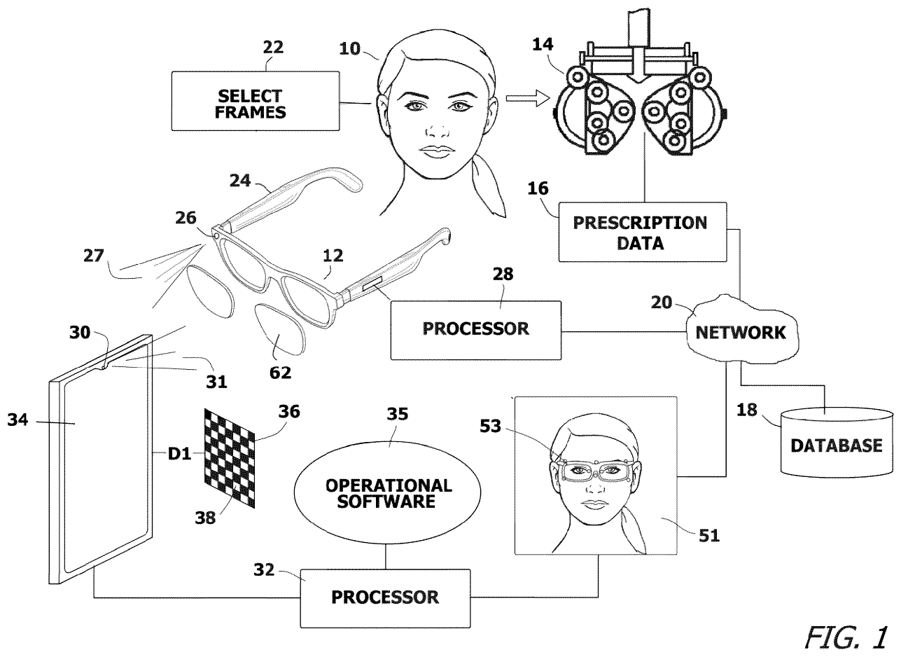

FIG. 1 is a block diagram schematic illustrating a first exemplary system for obtaining data needed to accurately manufacture prescription lenses for smart glasses;

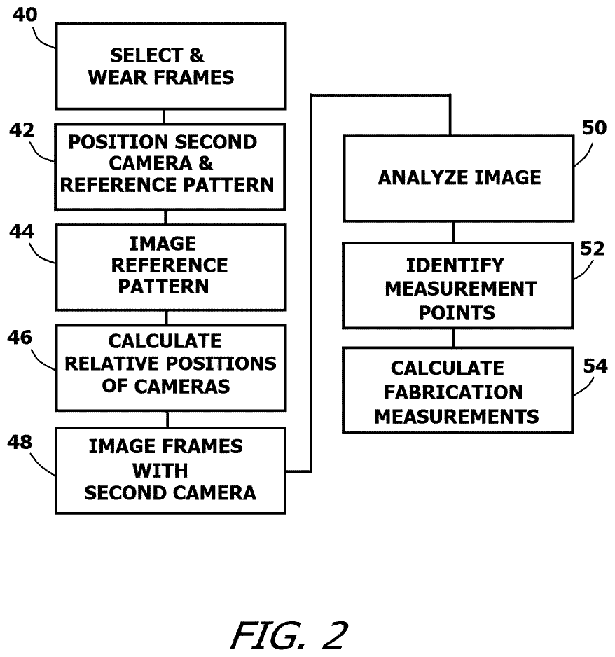

FIG. 2 is a block diagram showing a first methodology of the present invention system;

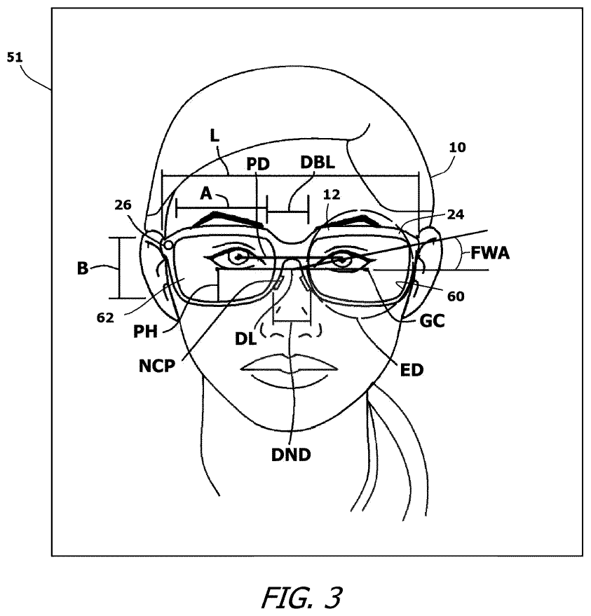

FIG. 3 is a front image of an individual wearing the frames of smart glasses and indicating some of the variables and common measurement points needing determination for the proper fabrication of prescription eyewear;

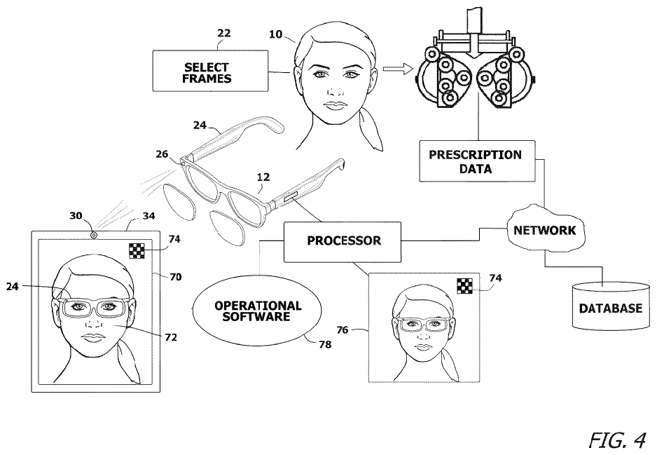

FIG. 4 is a block diagram schematic illustrating a second exemplary system for obtaining data needed to accurately manufacture prescription lenses for smart glasses;

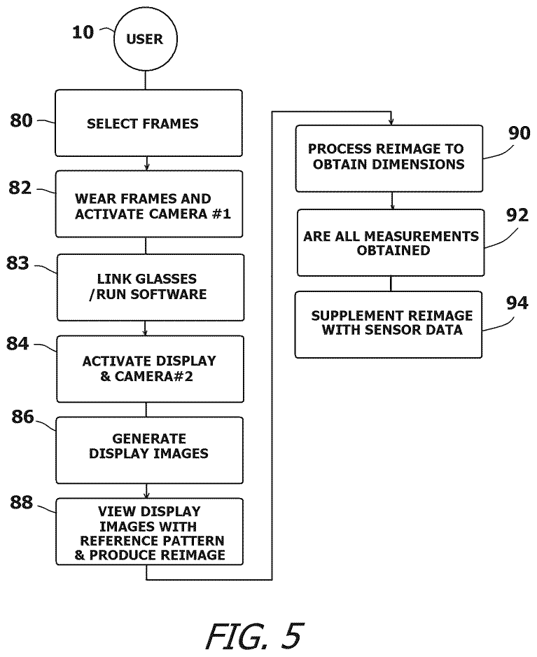

FIG. 5 is a block diagram showing a second methodology of the present invention system; and

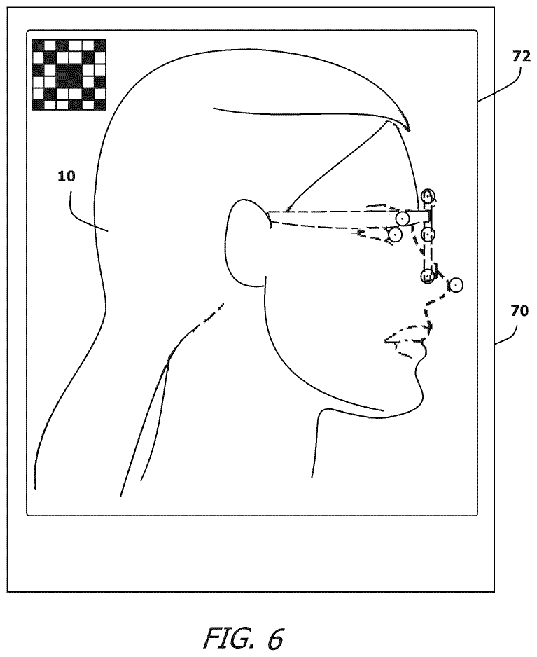

FIG. 6 is a side image of an individual wearing the frames of smart glasses and indicating some of the variables needing determination for the proper fabrication of prescription eyewear.

### DETAILED DESCRIPTION OF THE INVENTION

Although the present invention system and method can be used to accurately fabricate prescription lenses for a variety of smart glasses, only two exemplary embodiments are illustrated. These embodiments are exemplary and are presented for education and discussion. Accordingly, the exemplary embodiments should not be considered as limitations in the interpretation of the appended claims.

For the purposes of this description, “smart glasses” shall be considered all eyeglasses that have electronics that, among other features, include a camera and the ability to image. The smart glasses can optionally contain electronics able to produce positional data such as the angle of the eyeglass frames relative to the vertical plane. The term “eyeglass frames” shall be considered to be the frames of the smart glasses that contain the camera.

Referring to FIG. 1, it will be understood that a system user 10 who wants prescription lenses to be manufactured into a set of smart glasses 12 must first visit an optometrist or similarly qualified person in order to obtain a corrective lens prescription. Typically, an eye exam is conducted using diagnostic equipment 14, such as a phoropter. The diagnostic information obtained from the eye exam is used to generate prescription data 16. The prescription data 16 can be stored in a cloud accessible database 18 that is accessed through a data network 20, such as the Worldwide Web.

An eye exam need not be performed to use the present invention system. If prescription data 16 is required, the prescription data 16 can be obtained from records of old exams or even by analyzing the current eyewear of the user 10. It will therefore be understood that the prescription data 16 is obtained from some source and may be presented in many formats including a written prescription.

Once the prescription data 16 is obtained from some source, the user 10 selects the eyeglass frames 24 of the smart glasses 12 into which the prescription lenses are to be mounted. See Block 22. The user 10 can bring their own eyeglass frames 24. Alternately, samples of eyeglass frames 24 are made available to the user 10 at a fitting.

The smart glasses 12 contain a first camera 26 with a first field of view 27. The smart glasses 12 contain a first processor 28 or is linked to a device that contains a first processor 28. The user 10 who is being fitted for the smart glasses 12 is positioned proximate a second camera 30 that is separate and distinct from the first camera 26 of the smart glasses 12. The second camera 30 has a second field of view 31 and is linked to a second processor 32. The second camera 30 and second processor 32 can be separate components. However, it is preferred that an electronic device 34, such as a tablet computer, laptop computer, or smartphone, be used that contains both the second camera 30 and the second processor 32.

A reference pattern 36 is provided at a known position relative to the second camera 30 in the electronic device 34. As a result, the relative position between the second camera 30 and the reference pattern 36 is known. The reference pattern 36 can be any pattern or object with known dimensions. The reference pattern 36 is also positioned within the first field of view 27 of the first camera 26 in the smart glasses 12. In the shown embodiment, the reference pattern 36 is shown as a checkered pattern 38 that contains checker squares of known dimensions. Alternatively, the reference pattern 36 can be any object that has known dimensions, such as a coin, or a piece of paper currency. The reference pattern 36 can also be a sticker or photo that precisely images an object of known dimensions and is at a known relative position in space from the second camera 30.

Referring to FIG. 2 in conjunction with FIG. 1, it will be understood that the frames 24 of the smart glasses 12 are selected and worn by a user 10. See Block 40. The reference pattern 36 is positioned in the first field of view 27 of the first camera 26. See Block 42. The position of the reference pattern 36 in space relative to the second camera 30 is known. The first camera 26 in the smart glasses 12 is used to view the target area so that the reference pattern 36 can be imaged. This produces a reference pattern image with a known dimensional scale. Likewise, the smart glasses 12 are in the second field of view 31 of the second camera 30. The reference pattern 36 is at a known position relative to the second camera 30. As is indicated by Block 44, the first camera 26 in the smart glasses 12 images the reference pattern 36 in the target area. This produces a reference pattern image within the first processor 28 linked to the smart glasses 12.

The first processor 28 that is linked to the smart glasses 12 uses the reference pattern image of the reference pattern 36 to calculate the relative position in space between the first camera and the second camera. As a result, the relative position in space between the first camera and the second camera is calculated. Since the relative positions between the reference pattern 36 and the second camera 30 is known, the relative position and distance between the first camera 26 and the second camera 30 can also be determined. See Block 46. The relative position and distance between the first camera 26 and the second camera 30 is communicated to the second processor 32. This data can be communicated through a wire or wirelessly through various electronic methods or if an electronic displayed pattern is used, by having the pattern change shape based on the relative position in space between the first camera and the second camera, (such as a cube changing direction).

Sensors in electronic device 34 can be used to modify the pattern according to the orientation in space of camera 30. Alternatively, sensors in both the smart glasses 24 and the electronic device 34 can be used in conjunction, through electronic communication and processing in both devices, to modify the pattern to display relative orientation between the first camera 26 and the second camera 30.

The user 10 wearing the smart glasses 12 is in the second field of view 31 of the second camera 30. The second camera 30 is used to produce images 51 of the user 10 wearing the smart glasses 12. The second processor 32 that is linked to the second camera 30 analyses the images 51 with operational software 35. See Block 48 and Block 50. The relative positions in space between the first camera 26 and the second camera 30 is known, as is the scale of the images 51. The second processor 32 that is linked to the second camera 30 then identifies common measurement points 53 on the eyeglass frames 24 and the face of the user 10. See Block 52. Common measurement points 53 include measurement points that are traditionally used to obtain ophthalmic measurements. Common measurement points can also be identified on the image manually by the operator. With the key measurement points 53 identified and with the scale and relative position in space between the first and second cameras 26, 30 established, various dimensions and measurements needed to fabricate lenses can be taken from the images 51. See Block 54.

Referring to FIG. 3 in conjunction with FIG. 1, it will be understood that certain measurements must be taken from the eyeglass frames 24 that reference the anatomy of the user 10. Collectively, some of the variables that are needed to fabricate a set of prescription eyeglasses are present in Table 1 below:

TABLE 1
Frame Dimension Variables

| | |
|---|---|
| A - | Lens Length |
| B - | Lens Height |
| ED - | Effective Diameter |
| GC - | Geometrical Centers |
| DL - | Datum Line |
| L - | Frame Length |
| DBL - | Distance Between Lenses |
| FWA - | Frame Wrap Angle |

Anatomical Dependent Variables

| | |
|---|---|
| PH - | Pupil Height |
| PD - | Pupil Distance |
| PTA - | Pantoscopic Tilt Angle |
| RVD - | Rear Vertex Distance |

FIG. 3 shows the image 51 of a user 10 wearing the eyeglass frames 24 of smart glasses 12. The eyeglass frames 24 have lens openings 60 which can be fitted with prescription lenses 62 by the manufacturer. Referring to Table 1 in conjunction with FIG. 3, it will be understood that each model and style of eyeglass frames 24 has its own critical dimensions that must be known in order to shape the prescription lenses 62 for the eyeglass frames 24. Those measurement variables include the overall peripheral shape of the eyeglass frames 24. Eyeglass frames 24 retain the prescription lenses 62 in a lens plane. Typically, the lens plane associated with smart glasses 12 is at a slight angle relative to the vertical. This tilt angle is sometimes referred to as the “device panto” in the industry. The tilt of the lens plane is also affected by the tilt angle of the user's head. This tilt angle is caused by posture and the way an individual holds his/her head. The device panto is a difficult measurement to assess from a single face-front image.

Within the overall shape of the eyeglass frames 24 are the lens length “A” and the lens height “B”. There is an effective diameter “ED” as measured through the geometric center “GC” of each lens 62. The geometric centers “GC” of both lenses 62 align horizontally on the datum line “DL”. The distance between the geometric centers “DBC” is the distance between the geometric centers “GC” in the horizontal plane. The frame length “L” is the distance between temples in the horizontal plane. The bridge size, or distance between lenses “DBL,” is the minimum distance between the left and right lenses 62. The frame wrap angle “FWA” describes the horizontal angle of the lens plane in front of the eyes. The pantoscopic tilt angle “PTA” corresponds to the total vertical tilt of the lens plane. The proper pantoscopic tilt angle “PTA” for an individual is highly dependent upon the natural head posture of the individual. This is due to the vertical plane being a constant and any downward tilt of the head directly changing the tilt of the eyeglass frames 24 relative to the vertical plane. As such, the pantoscopic tilt angle “PTA” is the sum of the tilt angle caused by the device panto plus the tilt angle cause by head posture.

Other measurements that depend upon the anatomy of the individual wearing the eyeglass frames 24 include pupil height “PH”, pupil distance “PD”, and rear vertex distance “RVD”. The pupil height “PH” is the measured height of the pupils above the bottom of the prescription lenses 62. The pupil distance “PD” is the distance between pupils in the horizontal plane. The rear vertex distance “RVD” is the gap distance between the pupil and the lens at the point of the line of sight from the pupil to the camera.

The pantoscopic tilt angle “PTA,” pupil height “PH” and the rear vertex distance “RVD” are measurements that depend upon how the prescription lenses 62 are held in front of the eyes. These measurements also depend upon how the user 10 normally orients his/her head when looking through the prescription lenses 62, which determines the points on the lenses 62 where the line of sight passes through the lenses 62. Most, if not all, of the measurements of Table 1 are readily obtained from the captured images 51 of the smart glasses 12 when worn.

What is not known is how much the user 10 changes the orientation of his/her head when the user 10 reads, drives, stands, walks, watches television, or otherwise performs ordinary tasks while wearing eyeglasses. If the user 10 has a slight slouch or downward head inclination, the tilt angle affects the overall pantoscopic tilt angle “PTA” of the smart glasses 12 when worn. Variations to the pantoscopic tilt angle “PTA,” can also affect pupil height “PH” and rear vertex distance “RVD.” All three affect the line of sight through the prescription lenses 62. These variables may or may not be discernable from the collected images 51, depending upon the make and model of the eyeglass frames 24. If these variables cannot be accurately ascertained from the images 51, then these variables can be determined using various data obtained from the electronics in the smart glasses 12 or alternatively, by taking multiple display images 51 from different perspectives, or through other techniques.

With the smart glasses 12 and the electronic device 34 oriented in the manner previously described, alternate methods can be utilized to obtain the ophthalmic measurement needed to fill a lens prescription. Referring to FIG. 4, the same components as previously described are again shown. In this exemplary embodiment, the user 10 who is being fitted for the smart glasses 12 can be positioned in front of an electronic device 34 or vice versa. The electronic device 34 selected has both a second camera 30 and a display monitor 70. The electronic device 34 can be a tablet, laptop, or smartphone. Alternatively, the electronic device 34 can be an assembly, such as a table top computer with monitor and camera. In all examples, the display monitor 70 has access to the second camera 30 and can display the images 51 captured by the second camera 30. A mirror can also be used.

In one exemplary embodiment, the user 10 places the eyeglass frames 24 on his/her head and is imaged by the second camera 30. This produces a display image 72 of the user 10 wearing the eyeglass frames 24 and is shown on the display monitor 70. A software generated reference pattern 74 is added to the display image 72. The reference pattern 74 is a specific visual pattern of known dimensions. The reference pattern 74 is shown on the display monitor 70 in addition to the display image 72 of the user 10 and eyeglass frames 24. Scaling is determined when display image 72 with the reference pattern 74 is imaged by the first camera 26 and processed to determine the relative position in space and distance between the first camera 26 and the second camera 30.

As an alternate of showing the reference pattern 74 on a screen with the display image 72 can be the use of a physical pattern of known dimensions. The physical pattern can be an object such as a sticker with a checkerboard. The sticker can be attached to a display or mirror. Alternatively, the physical pattern can be an object of known shape and dimensions. For example, the smart glasses can function as the pattern if the dimensions of the smart glasses are known.

In the shown embodiment, the reference pattern 74 is shown as a checkered block that is located in one of the corners of the display image 72. This is merely exemplary, and it should be understood that the reference pattern 74 can be any graphic or object that has known dimensions. Furthermore, the reference pattern 74 can be displayed at any point within the display image 72. However, a more detailed orientation and position in space can be obtained if an electronically displayed pattern is used. An electronically displayed can change shape based on the relative position in space between the first camera 26 and the second camera 30, such as a cube changing direction. Alternatively, the orientation and position in space data can be transmitted between the electronic device 34 and smart glasses 12. Sensors in electronic device 34 can be used to modify the pattern according to the orientation in space of the second camera 30 or sensors in both smart glasses 24 and in the electronic device 34 can be used in conjunction, through electronic communication and processing in both devices, to modify the pattern to display relative orientation between the first and the second cameras 26, 30.

The electronic device 34 contains the second camera 30 that is directed toward the user 10 wearing the eyeglass frames 24. The display monitor 70 shows a display image 72 of the user 10 wearing the eyeglass frames 24. Once the reference pattern 74 is added to the display image 72, the display image 72 with the added reference pattern 74, is then viewed by the first camera 26 in the smart glasses 12. The scale becomes known once the display image 72 with pattern 74 is imaged by the first camera 26 and processed to determine the relative position in space and distance between the first camera 26 and the second camera 30.

Although the figures show use of a square checkerboard reference pattern 30, other objects can serve as a scale. For example, if the eyeglass frames 24 have known dimensions, the eyeglass frames 24 themselves can serve as the image scale. Likewise, if the display monitor 70 has known dimensions, the display monitor 70 can serve as a scale. Alternatively, a sticker of known dimension, or a sticker containing an image of known dimensions can be used.

The smart glasses 12 contain the first camera 26. The first camera 26 in the smart glasses 12 is separate and distinct from the second camera 30 of the electronic device 34. The display image 72 on the display monitor 70 is viewed by the first camera 26 in the eyeglass frames 24 of the smart glasses 12. This creates a reimage 76. The smart glasses 12 may run operational software 78 or may be linked to an external computer that runs the operational software 78. The operational software 78 can use the reference pattern 74 captured in the reimage 76 to determine many of the dimensional features of the eyeglass frames 24.

Although many dimensional features of the eyeglass frames 24 can be determined by taking scaled measurements from the reimage 76, some measurements can also be taken using the electronics within the smart glasses 12. The smart glasses 12 often contain one or more sensor devices such as inclinometer(s). The readings from sensor devices are utilized by the operational software 78. Sensor devices have the ability to measure a variety of relevant position data such as an inclination angle of the smart glasses 12 relative to a reference plane. Furthermore, as previously mentioned, the displayed pattern may have the ability to change shape. By having an electronically displayed pattern change shape based on the relative position in space between the first camera 26 and the second camera 30, that orientation and position in space data can be transmitted between the electronic device 34 and smart glasses 12. Sensors in electronic device 34 can be used to modify the pattern according to the orientation in space of the second camera 30. Alternatively, sensors in both smart glasses 24 and in the electronic device 34 can be used in conjunction to modify the pattern to display relative orientation between the first camera 26 and the second camera 30.

Both the reimage 76 and the position data are processed by the operational software 78. The reimage 76 shows the face and head of the user 10 wearing the eyeglass frames 24 with a reference pattern 74. Accordingly, the reimage 76 shows the physical features of the eyeglass frames 24 in relation to the anatomical features of the user's head 11. Using the reference pattern 74, both the frontal features of eyeglass frames 24 and the user 10 can be directly measured in a known scale and/or spatial orientation.

Referring to FIG. 5 in conjunction with FIG. 4, the details of the operation of the present invention system are described. In order to utilize the system, eyeglass frames 24 for a set of smart glasses 12 are selected. See Block 80. The eyeglass frames 24 are worn by the user 10 and the first camera 26 within the smart glasses 12 is activated. See Block 82. The smart glasses 12 are either loaded with operational software 78 or are electronically linked to a remote computer device that is running the operational software. See Block 83.

As indicated by Block 84, the display monitor 70 is activated along with its second camera 30. The second camera 30 of the display monitor 70 is directed toward the user 10 wearing the eyeglass frames 24. The second camera 30 captures the display image 72 of the user 10, wherein the display monitor 70 shows the display images 72. See Block 86. A pattern of known size and configuration is placed within the field of view of camera 26 and at a known position in space from the second camera 30. The pattern can be either physical or displayed electronically on the screen. The pattern may change shape based on the orientation of electronic device 34 or based on relative position in space between the smart glasses 12 and the electronic device 34.

The first camera 26 of the smart glasses 12 is directed toward the display monitor 70 and captures the display images 72 and pattern 74 being displayed. This produces the reimage 76. See Block 88. The reimage 76 is processed. Using the operational software 78, the features of the eyeglass frames 24 and the user 10 are measured with reference to the reference pattern 74. From the scaled reimage 76, most, if not all, of the measurements needed to fabricate the prescription lenses 62 for the eyeglass frames 24 can be determined. See Block 90. If not all required measurements can be obtained, the other electronics within the smart glasses 12 can be used to obtain supplemental data. See Block 92 and Block 94. As previously stated, the smart glasses 12 also contain one or more sensor devices, such as an inclinometers, that can send position data to the operational software 78.

In the system and method described above, only one display image 72 needs to be captured to generate the measurements required to produce proper prescription lenses 62. However, one image may be insufficient to obtain panto tilt angle “PTA,” which effects both pupil height “PH” and rear vertex distance “RVD.” As stated, the sensors in the smart glasses 12 can be used to determine these variables. However, another solution is possible. If the first camera 26 in the smart glasses 12 is used to take multiple pictures from different angles, the panto tilt angle is measurable with or without the need of sensor data.

Referring to FIG. 6, in conjunction with FIG. 4, a display image 72 is shown on the display monitor 70, wherein a side view of the user 10 wearing the smart glasses 12 is shown. Obviously, since the user 10 is not facing the display monitor 70, the first camera 26 in the smart glasses 12 cannot directly view the display monitor 70. This can be corrected by placing a timed capture feature into the display monitor 70. The second camera 30 of the display monitor 70 can be set to take a picture a few seconds after activation. In this manner, the user 10 can activate the second camera 30 of the display monitor 70 and face the second camera 30 at an offset angle. The second camera 30 captures the offset user 10 and presents the offset display image 72 on the display monitor 70. The offset image 72 will remain on screen until cleared or until a preset period of time passes. After the offset display image 72 is displayed, the user 10 can face the display monitor 70 and the offset display image 72. This can be done once or multiple times. The data contained within the offset display image 72 is used by the operational software 78 to calculate the panto tilt angle and any other required measurement that is unclear from the analysis of the face-forward image.

Alternatively, the user 10 can retain visual contact with the display monitor 70 and merely move his/her head while the display monitor 70 remains in the field of view. Orientation change can be achieved by moving the second camera 30 of the display monitor 70 and/or by the user 10 adjusting his/her head posture. For example, the user 10 can tilt his/her head downward while continuing to face and looking into the lens of the second camera 30. This provides stereo and/or panoramic image sets that enable stereo-based calculations for improved or additional eyewear measurements. The ability to alter the reference pattern outlined earlier can also be employed here to indicate the relative change in orientation between various images.

It will be understood that the exemplary embodiments of the present invention system that are illustrated are merely exemplary and that many aspects of the system can be redesigned in manners that are functionally equivalent. All such variations, modifications and alternate embodiments are intended to be included within the scope of the present invention as claimed.

What is claimed is:

1. A method of obtaining ophthalmic measurements needed to produce lenses for smart glasses, wherein the smart glasses are of the type that include a first camera, said method comprising the steps of:
providing smart glasses frames;
having a user wear said smart glasses frames;
providing a reference pattern of known dimensions;
providing a second camera at a known position from said reference pattern, wherein said second camera is used to take at least one user image of said user wearing said smart glasses frames;
imaging said reference pattern with said first camera producing a reference pattern image, wherein said reference pattern image is used to calculate relative positioning between said first camera and said second camera; and
analyzing said at least one user image with a scale determined from said relative positioning to determine said ophthalmic measurements needed to manufacture lenses for said smart glasses frames.

2. The method according to claim 1, wherein said lenses for said smart glasses frames are prescription lenses.

3. The method according to claim 1, wherein said reference pattern is selected from a group consisting of scale patterns, objects of known dimensions, and printed images of known dimensions.

4. The method according to claim 1, wherein said ophthalmic measurements needed to manufacture said lenses are selected from a group consisting of pupil distance, pupil height, lens length, lens height, effective diameter, distance between lenses, rear vertex distance, frame wrap angle and pantoscopic tilt angle.

5. The method according to claim 1, wherein providing a second camera includes providing an electronic device that contains said second camera, wherein said electronic device is selected from a group consisting of tablet computers, laptop computers, smartphones and computers connected to cameras.

6. The method according to claim 1, wherein said smart glasses further include sensor devices for sensing orientation of said smart glasses, wherein said sensor devices create data that is used in conjunction with said at least one user image to determine values for at least some of said ophthalmic measurements.

7. A method of obtaining ophthalmic measurements needed to produce lenses for smart glasses, wherein the smart glasses are of the type that include a first camera, said method comprising the steps of:
providing smart glasses frames;
having a user wear said smart glasses frames;
providing a second camera that images said user wearing said smart glasses frames and produces at least one display image;
displaying said at least one display image on a display screen;
viewing said display screen with said first camera in said smart glasses, wherein said first camera collects at least one reimage of said user wearing said smart glasses frames; and
analyzing said at least one reimage to determine said ophthalmic measurements needed to manufacture lenses for said smart glasses frames.

8. The method according to claim 7, further including adding a scale pattern to said at least one display image displayed on said display screen, wherein said at least one display image is scaled using said scale pattern.

9. The method according to claim 7, further including adding a scaled object to said at least one display image displayed on said display screen, wherein said at least one display image is scaled using measurement comparisons to said scaled object.

10. The method according to claim 7, wherein said lenses for said smart glasses frames are prescription lenses.

11. The method according to claim 7, wherein providing a second camera that images said user includes providing an electronic assembly that contains both said second camera and said display screen.

12. The method according to claim 7, wherein providing a second camera includes providing an electronic device that contains said second camera, wherein said electronic device is selected from a group consisting of tablet computers, laptop computers, smartphones and computers with cameras.

13. The method according to claim 7, wherein said ophthalmic measurements needed to manufacture said lenses are selected from a group comprising pupil distance, pupil height, lens length, lens height, effective diameter, distance between lenses, rear vertex distance, frame wrap angle and pantoscopic tilt angle.

14. The method according to claim 7, wherein said second camera images said user wearing said smart glasses frames from a single position.

15. The method according to claim 7, wherein said second camera images said user from a plurality of positions.

16. The method according to claim 7, wherein said smart glasses further include sensor devices for sensing orientation of said smart; glasses, wherein said sensor devices create data that is used in conjunction with said at least one reimage to determine values for at least some of said ophthalmic measurements.

17. A method of obtaining ophthalmic measurements needed to fabricate lenses for smart glasses, said method comprising the steps of:
providing smart glasses frames into which said lenses are to be set, wherein said smart glasses frames contain a first camera;
providing a second camera;
wearing said smart glasses frames;
using said first camera to image an object at a known position relative to said second camera;
using said image of said object to calculate a spatial orientation between said first camera and said second camera;
using a second camera to image said smart glasses frames while being worn to obtain at least one display image;
obtaining said measurements from said image of said smart glasses frames using a scale determined from said spatial orientation between said first camera and said second camera, wherein said ophthalmic measurements are utilized in fabricating said lenses.

18. The method according to claim 17, wherein said lenses for said smart glasses frames are prescription lenses.

19. The method according to claim 17, wherein said object is selected from a group consisting of scale patterns, objects of known dimensions, and printed images of known dimensions.

20. The method according to claim 17, wherein providing a second camera includes providing an electronic device that contains said second camera, wherein said electronic device is selected from a group consisting of tablet computers, laptop computers and smartphones.
